(19) United States
(12) Patent Application Publication
(10) Pub. No.: US 2024/0017852 A1
(43) Pub. Date: Jan. 18, 2024

(54) SATELLITE CONFIGURATION FOR OPERATION IN THE THERMOSPHERE

(71) Applicant: Earth Observant Inc., El Granada, CA (US)

(72) Inventors: Christopher Thein, El Granada, CA (US); Nathan Rosenblad, El Granada, CA (US); James DiCorcia, El Granada, CA (US)

(21) Appl. No.: 17/987,527

(22) Filed: Nov. 15, 2022

Related U.S. Application Data
(60) Provisional application No. 63/279,872, filed on Nov. 16, 2021.

(51) Int. Cl. B64G 1/24; B64G 1/40; B64G 1/52; F03H 1/00; G02B 23/02

(52) U.S. Cl. CPC B64G 1/242; B64G 1/413; B64G 1/52; F03H 1/0075; G02B 23/02

(57) ABSTRACT

A satellite having a longitudinally elongated body and being capable of operating in the thermosphere. The satellite can be powered by an electric rocket engine, and includes a remote sensing system configured to obtain images of Earth. An elongated axis about which the elongated body extends can be generally aligned with a forward direction of the satellite, with a viewing angle from the satellite oriented transverse to the elongated axis. A center of mass of the satellite can be forward of a center of drag to produce positive natural stability. The remote sensing system, which can be part of a payload, can include a movable mirror and one or more movable optical elements. A first mirror can be pivoted, and/or other optical elements, including the payload, can be rotated about the axis of the elongated body. Counter-acting masses can be used to null motion of the movable components.

### CROSS-REFERENCE TO RELATED APPLICATIONS

The present application claims the benefit of U.S. Provisional Patent Application Ser. No. 63/279,872, filed Nov. 16, 2021, which is incorporated herein by reference in its entirety.

### TECHNICAL FIELD

The present disclosure generally relates to Earth orbiting satellites, and more particularly, but not exclusively, to low Earth orbiting satellites having unique vehicle configurations.

### BACKGROUND

Operating a spacecraft in relatively very low orbit, even though the atmosphere is rarefied, can result in the production of atmospheric drag, which can reduce spacecraft velocity and ultimately contribute to orbital decay. The level of atmospheric drag in very low orbit can be sufficient to deorbit conventional spacecraft geometries in extremely short periods of time. Further, the configuration of at least certain types of sensing systems and the associated size of the spacecraft that contains such remote sensing systems can contribute to the level of atmospheric drag that can be experienced by the spacecraft. Further, operation of at least certain components of such sensing systems can impart undesirable torque, as well as altitude disturbances, that can further contribute to an increase in atmospheric drag. Some existing systems have various shortcomings relative to certain applications. Accordingly, there remains a need for further contributions in this area of technology.

### SUMMARY

One embodiment of the present disclosure is a unique low Earth orbiting satellite. Other embodiments include apparatuses, systems, devices, hardware, methods, and combinations for configuring a low Earth orbiting satellite. Further embodiments, forms, features, aspects, benefits, and advantages of the present application shall become apparent from the description and figures provided herewith.

### BRIEF DESCRIPTION OF THE FIGURES

FIGS. 1A-1D illustrate side, top, front, and top views, respectively, of an exemplary low Earth orbiting satellite.

FIG. 2 illustrates a simplified side view representation of an exemplary embodiment of a low Earth orbiting satellite.

FIG. 3 illustrates a block diagram of an exemplary control system for a low Earth orbiting satellite.

FIGS. 4-7 illustrate simplified side view representations of exemplary embodiments of low Earth orbiting satellites.

FIGS. 8A and 8B illustrate side and front views, respectively, of an exemplary embodiment of a low Earth orbiting satellite having movable payload, at least a portion of which is displaceable relative to other portions of the payload and/or low Earth orbiting satellite.

FIG. 9A illustrates a first exemplary embodiment of an inertia nulling system that can be utilized with embodiments of a low Earth orbiting satellites disclosed herein.

FIG. 9B illustrates a second exemplary embodiment of an inertia nulling system that can be utilized with embodiments of a low Earth orbiting satellites disclosed herein.

FIGS. 10A-10C illustrate embodiments of a low Earth orbiting satellite having a fin configurations with associated centers of gravity located forward of corresponding centers of drag.

FIG. 11A illustrates an embodiment of a low Earth orbiting satellite having material components on forward and leading edges of a satellite body and fins, respectively, of the satellite.

FIG. 11B illustrates an embodiment of a low Earth orbiting satellite in which an electric rocket engine of the satellite can be placed in a mode to alter a local plasma environment.

FIGS. 12A-12G illustrate front views of examples of configurations and locations at which one or more fins of a low Earth orbiting satellite can be positioned relative to at least a body or fuselage of the satellite.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

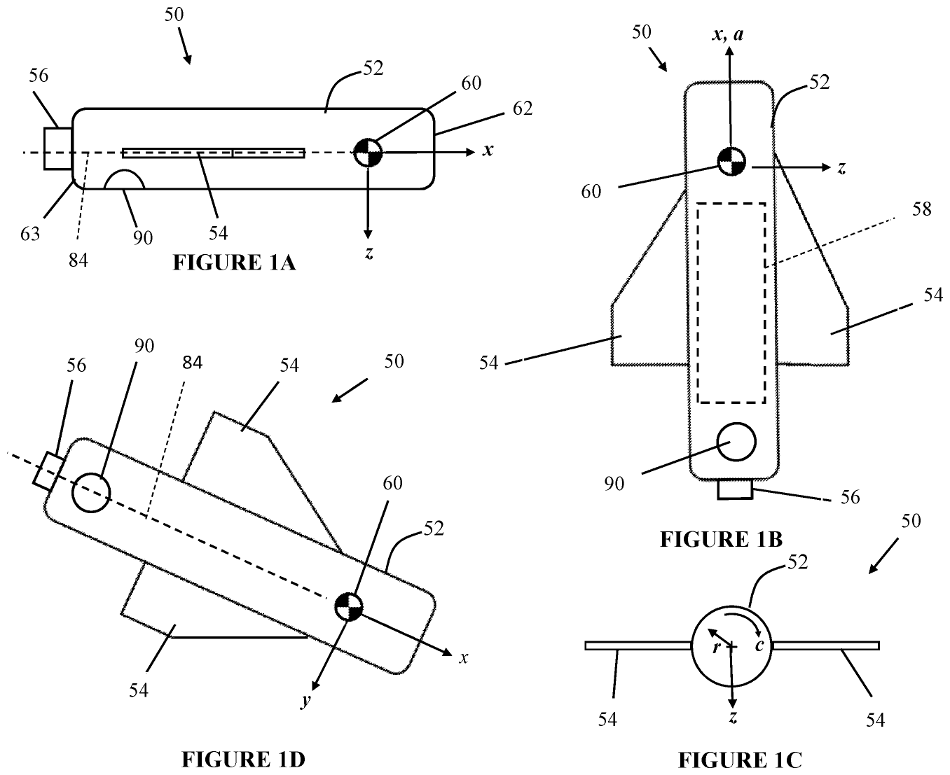

With reference to FIGS. 1A-1D, a low Earth orbiting satellite 50 is disclosed which can be configured to collect sensory information during orbital flight. The low Earth orbiting satellite 50 may be referred to herein as a satellite, vehicle, orbital vehicle, etc. No limitation is hereby intended with respect to various usages of the term as all will be understood to refer to the same. Also as will be appreciated by those of skill in the art, the schematics presented in FIGS. 1A-1D are intended to depict various functional components of the satellite 50 and do not imply specific orientation, dimensions, arrangement of components, and/or numbers of components.

The satellite 50 can be constructed for operation at low Earth orbit altitudes in the thermosphere, anywhere at altitudes ranging from at least 50 miles and beyond, including but not limited from 50 miles to 600 miles, and in some situations preferably from 50 miles to 23,000 miles, where images or other sensory information of Earth can be obtained through any variety of sensors. In some forms the satellite 50 is configured to transmit data in real time, but in other forms and/or modes of operation the satellite 50 can process information onboard and transmit a reduced data set.

The satellite 50 generally includes a longitudinally oriented body (or fuselage) 52, one or more fins 54 that can be used as solar arrays and/or antennas, and an electric rocket engine 56, also referred to herein as a rocket thruster, useful to assist in countering the effects of drag while operating in low Earth orbit. The body 52 is sized to accommodate a payload 58 that can include, at least in part, a remote sensing system, such as, that can include several different components (some of which may be described and/or illustrated later in the application). According to certain embodiments, the payload 58 is a telescopic payload.

The rocket thruster 56 can take a variety of forms. For example, according to certain embodiments the rocket thruster 56 is an ion thruster, including, for example, a Hall-effect thruster. While reference may be made below to particular types of electronic rocket thrusters 56, such as, for example, Hall-effect thrusters, no limitation is hereby intended that the rocket thruster 56 in any given embodiment be limited to being a Hall-effect thruster, or any other type of thruster, unless indicated explicitly to the contrary. Further, although the illustrated embodiment depicts a single block to represent a rocket thruster 56, it will be appreciated that additional rocket thrusters 56 can be used on the satellite 50. For example, multiple rocket thrusters 56 can be used at the location of the single block represented in the figures. Additionally, one or more rocket thrusters 56 can be located elsewhere around the satellite 50. For example, multiple rocket thrusters 56 can be festooned at multiple locations and/or on multiple surfaces to provide specific thrust vectors with regard to the bulk motion of the satellite 50. As will be appreciated, the rocket thruster 56 can be used to enable efficient orbital maneuvers, one example of which includes drag makeup in very low Earth orbit missions.

To aid in some of the discussion herein, a Cartesian coordinate system has been illustrated in FIGS. 1A-1D and which includes an x-axis generally along the direction of the longitudinally oriented body 52, a y-axis out a lateral direction of the body 52, and a z-axis out the bottom of the satellite 50. While in orbit, the x-axis will generally be in the direction of orbital velocity, the z-axis will point to the Earth, and the y-axis will point out the side of the satellite 50. The axis system can be defined to uphold the so-called ‘right hand rule.’

As will be appreciated, the origin of the axis system can be anywhere in the satellite and for purposes of illustration is forward of the center of mass (CoM) 60 as shown in FIG. 1D. As used herein, terms such as ‘forward’ or ‘aft’ generally describe a relative position along a longitudinal axis, or axis of extension, 84 of the satellite 50, with ‘forward’ intended to denote a position away from the rocket thruster 56 out of a leading edge 62 of the satellite 50 and ‘aft’ intended to denote a position toward the rocket thruster 56 and out the back 63 of the satellite 50 or fuselage 52. Similarly, terms such as ‘lateral’ or ‘starboard’ or ‘port’ generally describe a relative position along the lateral axis y, with ‘starboard’ intended to denote a position in the positive y direction and ‘port’ intended to denote a position in the negative y direction.

As seen in FIG. 1C, to further aid in alternative and/or additional aspects of the description herein, a polar coordinate system can be defined about the fuselage 52 and which includes a radial direction ‘r’, circumferential direction ‘c’, and an axial direction ‘a’ (which is generally in the same direction as Cartesian axis x). Though the cross section in the schematic shown in FIG. 1C is circular, no limitation is hereby intended for the cross sectional shape. Nevertheless, the polar coordinate system can still be used to denote relative positioning for purposes of description herein. For example, the cross sectional shape of the fuselage 52 can be octagonal where use of the polar coordinate system can still be used to denote relative positioning within and about the body 52.

Various embodiments disclosed herein can have features to maximize the ballistic coefficient of the satellite 50. In some forms, the ballistic coefficient can be maximized while maximizing payload volume. In one non-limiting embodiment, the satellite 50 has a ballistic coefficient of 100 kg/m² (about 4.2 lb./ft²). Some shapes contemplated for the fuselage 52 include cigar shapes, fish shapes, and missiles.

The payload 58, such as, for example, a telescopic payload, can be arranged along the longitudinal extension of the fuselage 52. As will be described further below, according to certain embodiments in which the payload 58 is a telescopic payload, the payload 58 can include an angled mirror to image the Earth below the orbiting satellite 50. Such angled mirror can be located in forward of, or aft of, an imager used in the telescopic payload 58 used to convert a visual image to digital information. The shape of the structure and relative placement of various components in some embodiments can create a relative placement of the center of mass 60 of the satellite 50 being in a position forward of a center of drag of the satellite 50. Configurations can be provided to include a mixture of construction materials for structural members as well as non-structural members having chemical/compositional/material properties selected to survive the harsh environment in the thermosphere. For various embodiments herein it is envisioned that the mission length in orbit is multiple months up to one or more years.

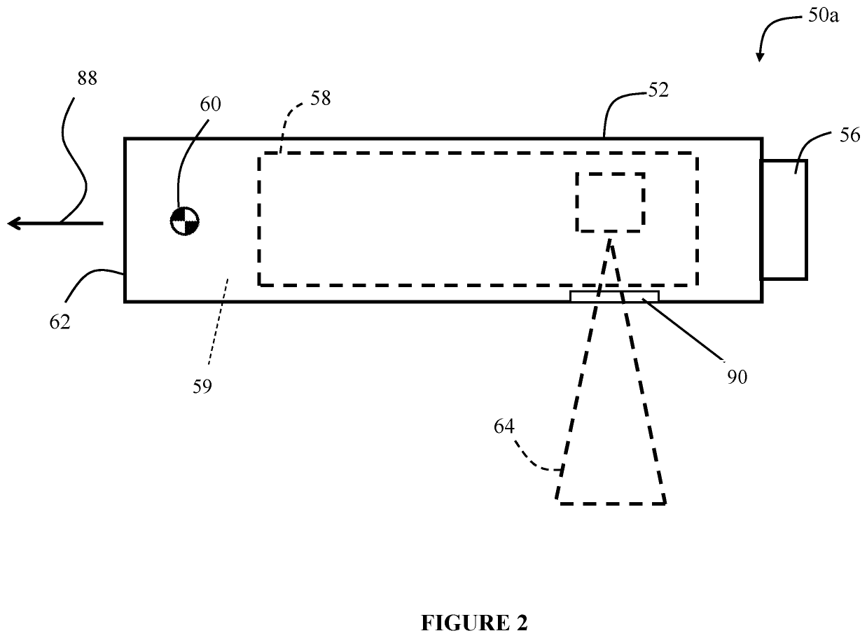

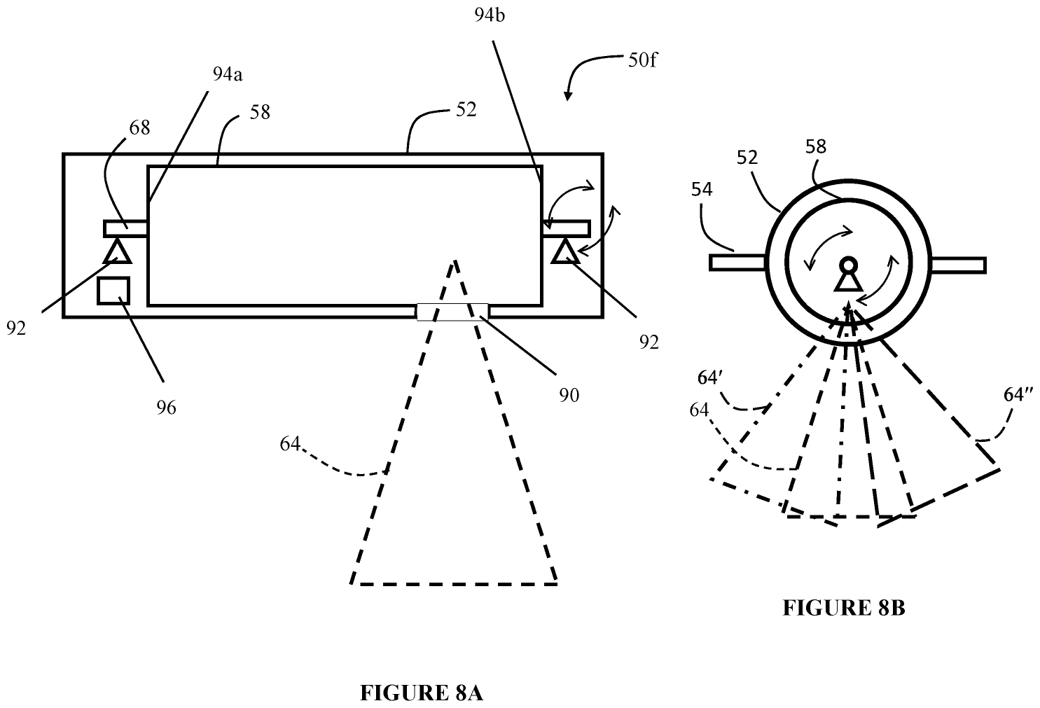

Various configurations are depicted in FIGS. 2-10G where like reference numerals refer to like elements. It will be appreciated that unless described to the contrary, one or more features of any given figure can be combined with one or more features with one or more of the other figures. To set forth just one non-limiting example, feature(s) of FIG. 2 can be combined with features discussed in connection with one or more of FIGS. 8A-12G, among potentially other combinations.

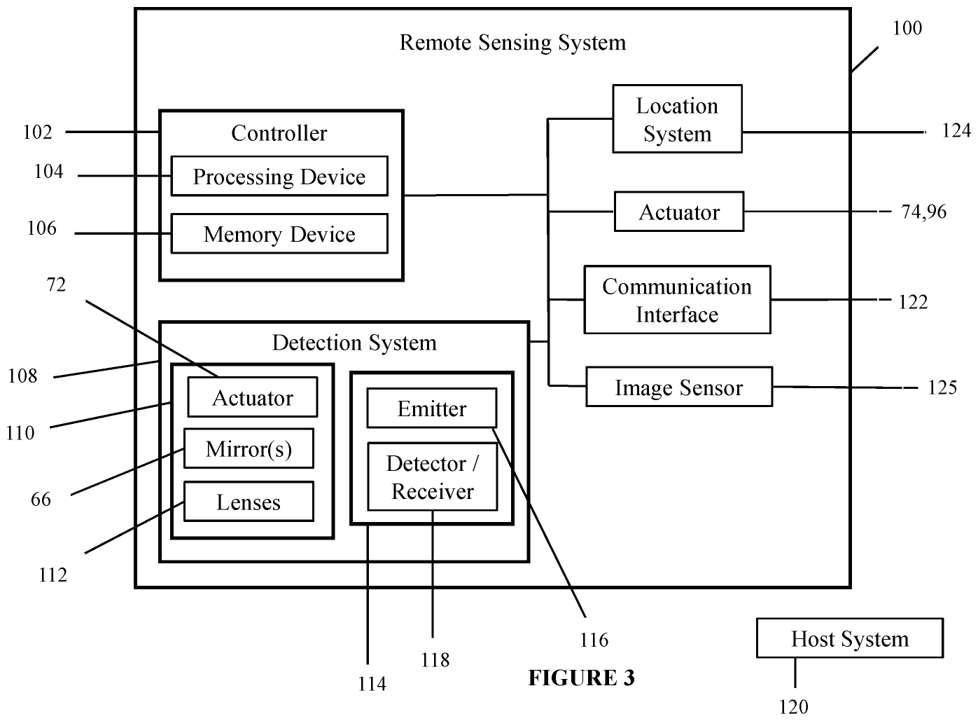

Turning now to FIG. 2, one embodiment of the satellite 50a is illustrated in which the payload 58 is located within an at least partially enclosed interior area 59 of the body or fuselage 52. The payload 58 can be, or otherwise can include, a remote sensing system 100. Referencing FIG. 3, according to certain embodiments, the remote sensing system 100 can include a controller 102 having one or more processors 104 and one or more memory devices 106. The one or more processors 104 can be embodied as, or otherwise include, any type of processor, controller, or other compute circuit capable of performing various tasks such as compute functions and/or controlling the functions of the remote sensing system 100. For example, the processor 104 may be embodied as a single or multi-core processor(s), a microcontroller, or other processor or processing/controlling circuit. In some embodiments, the processor 104 can be embodied as, include, or otherwise be coupled to an FPGA, an application specific integrated circuit (ASIC), reconfigurable hardware or hardware circuitry, or other specialized hardware to facilitate performance of the functions described herein. Additionally, in some embodiments, the processor 104 may be embodied as, or otherwise include, a high-power processor, an accelerator co-processor, or a storage controller. In some embodiments still, the processor 104 may include more than one processor, controller, or compute circuit.

The memory device 106 of the illustrative controller 102 can be embodied as any type of volatile (e.g., dynamic random access memory (DRAM), etc.) or non-volatile memory capable of storing data therein. Volatile memory may be embodied as a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM).

In some embodiments, the memory device 106 may be embodied as a block addressable memory, such as those based on NAND or NOR technologies. The memory device 106 may also include future generation nonvolatile devices, such as a three dimensional crosspoint memory device (e.g., Intel 3D XPoint™ memory), or other byte addressable write-in-place nonvolatile memory devices. In some embodiments, the memory device 106 may be embodied as, or may otherwise include, chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance.

The remote sensing system 100 can also include detection system 108 that is used to images or other sensory information of Earth obtain. The components of the detection system 108 can vary based on the type of image or sensory information that is being obtained. For example, according to certain embodiments, the detection system 108 can be a camera system or a telescopic system 110 or other optical system that is used in connection with detection using visible light. Such a telescopic system 110 can include one or more mirrors 112 for at least one of, if not both, redirection of light and/or optical gain, including with respect to increasing optical power. As discussed below, such a mirror 66 may, or may not, be used in connection with other mirrors. Further, the mirror(s) 66 can have a variety of shapes and configurations, including, for example, having a relatively flat or curved reflective surface. As discussed below, the mirror 66 can also be configured, including oriented, to redirect light in a direction that can assist in minimizing the cross sectional size of the body or fuselage 52, and thereby assist in minimizing atmospheric drag on the satellite 50. Further, as discussed below, according to certain embodiments, the detection system 108 can include, or be operably coupled to, one or more actuators 72 that can assist in selectively displacing the payload 58 or portions of the payload 58, including, for example, the mirror 66, telescopic system 110, and/or detection system 108, among other portions of the payload 58. The telescopic system 110 can also include one or more lenses 112, including, for example, one or more objective lenses that can assist with focusing an image(s) being obtained via use of the telescopic system 110, and one or more magnification lenses that can assist with magnification of such an image(s). Additionally, while FIG. 2 illustrates a single telescopic system 110 for a payload, the payload 58 can also consist of two or more telescopic systems 110, including, for example, two or more telescopic imaging assemblies comprises one or more mirrors 66 and lenses 112. Additionally, in some cases, each of the plurality of telescopic systems 110 may or may not be identical to at least one other telescopic system 110, such that each telescopic system 110 can be focused on the same area of interest in Earth for stereoscopic purposes, or focused on disparate locations for increased collection volume.

Additionally, or alternatively, the detection system 108 can include a sensor system 114 that is configured to obtain images using, for example, the infrared, near visible, and/or electromagnetic spectrums. For example, according to certain embodiment, the sensor system 114 can one or more of a LIDAR system, a radar detection system, and/or an ultrasonic detection system, among other sensor systems. Thus, for example, according to certain embodiments, the sensor system 114 can include an emitter 116 that can emit a signal or energy, including, for example, light, radio waves, and/or ultrasonic sound waves, among other outputs, and a detector or receiver 118 can detected a corresponding response or return signal.

Images and/or other information obtained via use of the detection system 108 can be digitized by the controller 102, and stored in the memory device 106 and/or communicated to a remote host system 120. According to certain embodiments, the remote host system 120 can be located on Earth and can wirelessly receive and/or communicate transmissions to/from via the remote sensing system 100 via a communication interface 122 of the remote sensing system 100. Thus, for example, the remote sensing system 100 can include one or more antennas and/or transceivers. The host system 120 can also be adapted to control certain aspect of the operation of satellite 50 and/or remote sensing system 100, including, for example, control the direction of travel, altitude, and speed of the satellite 50 and/or the actuator(s) 72 of the remote sensing system 100, among other aspects of the satellite 50 and/or the remote sensing system 100.

The controller 102 can also include a location system 124, such as, for example, a global positioning system, that can not only assist in guidance of the satellite 50, but also provide an indication of a corresponding location for the images or information obtained via use of the detection system 108, and/or information indicative used to determine when, and if, the mirror(s) 66 and/other portions of the payload 58 are to be displaced via operation of the associated actuator(s) 72.

As seen in FIG. 2, according to certain embodiments, the payload 58, including the remote sensing system 100, can be located in a position on and/or in the satellite 50 such that the CoM 60 is located in a forward position relative to the rocket thruster 56. Further, the shape of the body or fuselage 52 can be elongated generally along the axis of extension 84 of the satellite and thus along the x-axis, to minimize the frontal area of the body or fuselage 52 and maximize the ballistic coefficient. As illustrated, the axis of extension 84 of the satellite 50 can generally coincide with the direction of travel of the satellite 50, as generally indicated by the arrow 88. The telescopic payload 58, accordingly, is arranged to be packaged inside the interior area 59 of the elongated fuselage 52.

In the illustrated embodiment, a field of view 64 of the detection system 108, including the direction at which light or other energy at least enters into the detection system 108 can be at an angle that is not parallel to the axis of extension 84, x-axis, and/or the direction of travel of the satellite 50a. Moreover, the field of view 64 can extend out through a covered or uncovered opening 90 in the fuselage 52, and can extend in a generally downward direction toward Earth, such as in generally in the z-direction. While the field of view 64 can be located at a variety of locations forward of the rocket thruster 56, according to certain embodiments the field of view 64 can extend from a location of the satellite 50 that is forward of, as well as located in proximity to, the rocket thruster 56 and at an angle relative to elongated fuselage 52.

The fuselage 52 can be symmetrically disposed and extend along a geometrically identified axis (as illustrated in the embodiment in FIG. 2), but in some forms the fuselage 52 need not be symmetrical and thus an axis may not be in a geometric center of such distribution. Nevertheless, it will be generally understood that the fuselage 52 is generally elongate along the x-axis and that the field of view 64 is transverse to that axis. In some forms the field of view 64 is at a right angle to a geometric center of the fuselage 52 and/or to an arbitrary x-axis drawn through the fuselage 52 but still generally along the elongate direction. In short, the field of view 64 is at an angle to the elongate direction of the fuselage 52, and in some forms is at a right angle to the elongate direction.

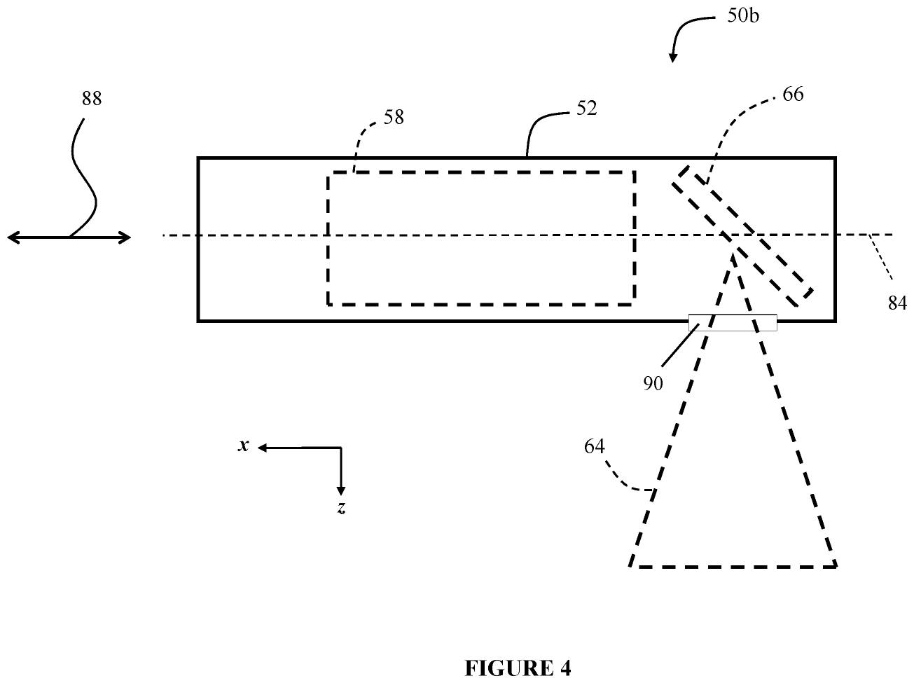

FIG. 4 illustrates another embodiment in which the satellite 50b that includes a relatively flat, non-curved mirror 66 as a first mirror 66. Although only one mirror 66 is depicted in the illustrated embodiment, it will be appreciated that any form of payload 58 in the form of a telescopic payload can include one or more mirrors where the mirrors can take any variety of forms, including, for example, flat, concave, convex, and/or parabolic, as well as various combinations thereof. It will be appreciated that the mirror 66 can reflect or redirect light, such as, for example, light that may have entered into the fuselage 52 in a direction that can coincide with the field of view 64, and direct or reflect the light toward other elements of the payload 58 for imaging by an imaging sensor 125 (FIG. 3) of the remote sensing system 100. As previously discussed, other elements of the payload 58 can include additional optical components such as, for example, lenses 112 of any variety of types, among other components.

The mirror 66 depicted in FIG. 4 can remain in a relatively static position relatively to the fuselage 52 and/or to other components of the payload 58. The angle at which the mirror 66 is oriented relative to the fuselage 52, direction of travel of the satellite 50b, direction of the field of view 64, and/or the payload 58 can vary. For example, as seen in FIG. 4, the mirror 66 is orientated at an angle that is neither perpendicular nor non-parallel to either the field of view 64, direction of travel of the satellite 50b, and/or the axis of extension 84 of the fuselage 52. The angle at which the mirror 66 is positioned can be based on least on part on other components of the telescopic system 110, including, for example, one or more other mirrors 66 and/or lenses 112. Further, according to the embodiment illustrated in FIG. 4, the mirror 66 is generally adapted to redirect light towards other portions of the payload 52, while other components of the payload 58 and/or the associated telescopic system 110, such as, for example one or more lenses 112, can be utilized for at least purposes of optical gain. FIG. 4 also illustrates an example in which at least one mirror 66, if not each mirror, is located within the fuselage 52 but outside of the payload 58.

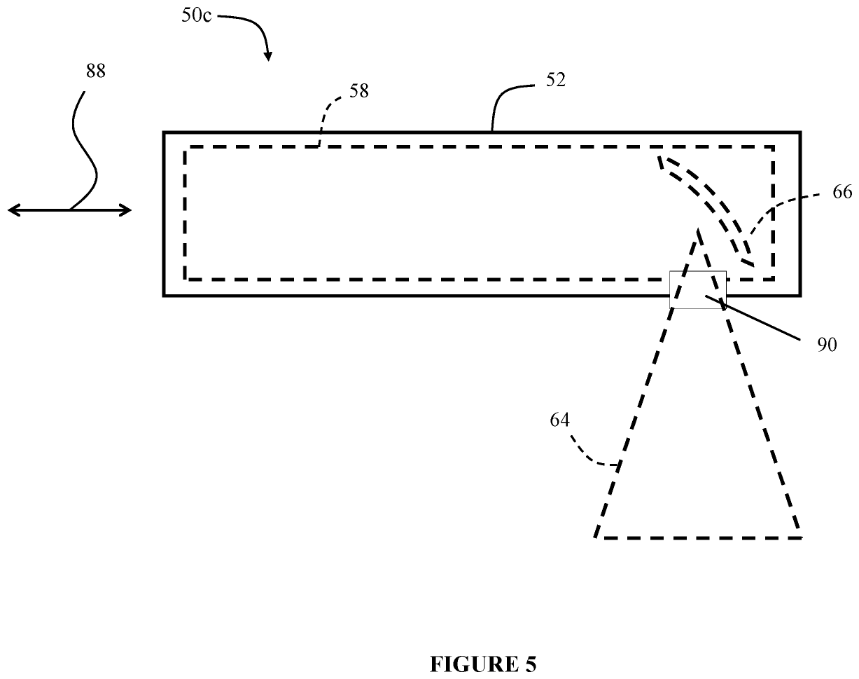

FIG. 5 illustrates an alternative embodiment of a satellite 50c in which rather than the mirror 66 having a generally flat profile, and, more specifically, a generally flat reflective surface, the mirror 66 has a generally curved profile, and, more specifically, a curved reflective surface. Similar to the mirror 66 shown in FIG. 4, the mirror 66 shown in FIG. 5 is angled to redirect incoming light in a direction that is different than the direction at which the light entered into the fuselage 52 an in a direction toward one or more other components of the telescopic system 110. Thus, as with the mirror 66 in FIG. 4, the mirror 66 shown in FIG. 5 can also direct light in a direction that is the mirror 66 is orientated at an angle that is neither perpendicular nor non-parallel to either the field of view 66, direction of travel of the satellite 50c, and/or the axis of extension 84 of the fuselage 52.

Unlike the mirror 66 shown in FIG. 4, in addition to redirecting light, the curved profile of the mirror 66 shown in FIG. 5, and moreover of the reflective surface of the mirror, is also adapted to increase optical gain. Thus, with the curved profile, the mirror 66 illustrated in FIG. 5 can also be part of a powered image path of the telescopic system 110. Additionally, unlike the embodiment shown in FIG. 4, in FIG. 5 the mirror 66 is illustrated as being part of the payload 58.

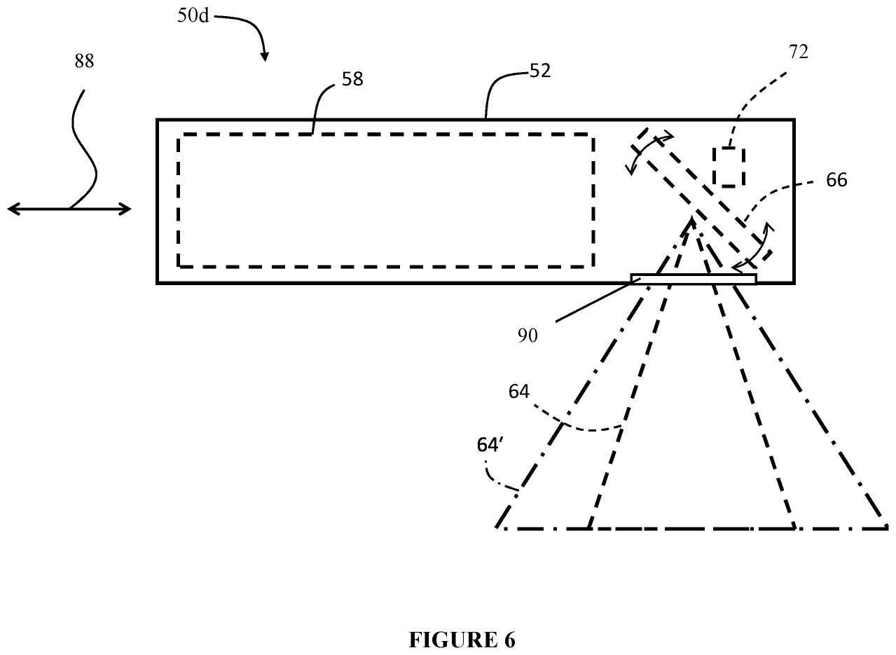

FIG. 6 illustrates an additional and/or alternative embodiment to FIGS. 3 and 4 in which the first mirror 66 of the satellite 50d is configured as a selectively movable or displaceable mirror 66 which can create a movable field of view 64. The arc shaped arrows in FIG. 6 indicate potential rotational displacement of the mirror 66. According to certain embodiments, the movable mirror 66 can be structured to pivot, such as, for example, via selective operation of an actuator 72, and thereby move the field of view 64 and/or expand the field of view from a first field of view 64 to a second field of view 64′. In one non-limiting form the movable mirror 66 can be mounted to a simple pivot which provides a single degree of freedom, but other forms are also contemplated. For example, according to certain embodiments, the mirror 66 can be coupled to a flexure joint or a mechanical joint, including but not limited to, a mechanical joint that utilizes sliding or rotating joint surfaces. To set forth just one non-limiting example, the movable mirror 66 can be captured by a ball and socket mechanism permitting greater freedom of movement relative to the body or fuselage 52. The ability to move the mirror 66 can accommodate a change in view of the mirror 66 without adjusting a tilt angle of the fuselage 52, and thus without making a change in orientation of the satellite 50d with respect to the direction of travel that could increase atmospheric drag.

The ability to selectively displace the mirror 66 can permit relative placement between the body or fuselage 52 and mirror 66 to optimize the attitude of the vehicle 50 (e.g. to minimize drag) while still capturing a relevant field of view of the Earth below. Further, according to certain embodiments, operation of the actuator 72 so as to displace the mirror 66 can be in response to a location of the satellite 50d, such as, for example, in response to a decision by the controller 102 based, at least in part, on location information provided by the location system 124 and/or detection of by the remote sensing system 100 of a the detection system 108 capturing an image(s) or other information pertaining to a phenomenon or predetermined trigger condition. Alternatively, or optionally, operation of the actuator 72 can be based on an operator command, such as, for example, a command communicated to the remote sensing system 100 from an operator at the host system 120. Additionally, or alternatively, according to other embodiments, selective displacement of the mirror 66, such as, for example, via control the actuator 72, can be performing using an artificial intelligence engine and/or a neural network of the remote sensing system and/or the host system 120.

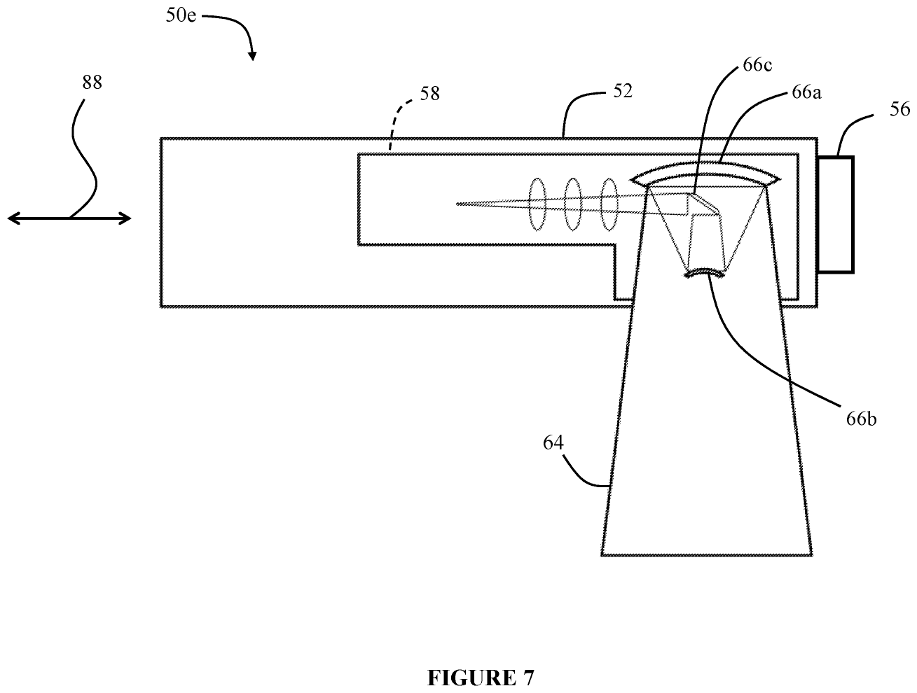

FIG. 7 illustrates another embodiment of a satellite 50e in which the telescopic system 110 includes one or more mirrors 66a, 66b configured to increase optical gain, and one or more mirrors configured to redirect light. For example, as seen in FIG. 7, according to the illustrated embodiment, a first mirror 66a and a second mirror 66b each have curved profiles such that the first and second mirrors 66a, 66b are power mirrors that can be used for at least optical gain. According to such an embodiment, light that is visible via the field of view 64 can travel to the first mirror 66a, and be focused down by the concave profile of the first mirror 66a to the second mirror 66b. The concave profile of the second mirror 66c can then further focus the light down onto another mirror, which may be another power mirror or a mirror to redirect the light. In the illustrated example, light can travel from the second mirror to one or more other mirrors for redirection, including, for example, a third mirror 66c. Thus, in the illustrated embodiment, light passes from the second mirror 66b to the third mirror 66c, where the light is bent by the third mirror 66c and redirected into one or more optical lenses 112, such as, for example, three lenses 112a-c, among other components, that are part of the telescopic system 110, and, moreover, of a telescope. Even with the inclusion of multiple mirrors 66a-c, the shape of the telescopic system 110, and thus of at least the fuselage 58 in which the telescopic system 110 and associated payload 58 are housed, is still primarily longitudinal so as to maintain a shape that can minimize atmospheric drag.

FIGS. 8A and 8B illustrate side and front views, respectively, of an exemplary embodiment of a low Earth orbiting satellite 50f having movable payload 58, at least a portion of which is displaceable relative to other portions of the payload 58 and/or satellite 50f. The arc shaped arrows indicate potential movements about the various pivot points 92 which are depicted as triangles in these. As with other embodiments discussed herein, the features illustrated in FIGS. 8A and 8B can be incorporated into other satellite embodiments discussed herein.

According to the illustrated embodiment, the payload 58 can be rotatingly coupled to the fuselage 52 such that relative motion is permitted between the two. As depicted in FIGS. 8A and 8B, according to certain embodiments, the payload 58, and/or portions of the payload 58, including, for example, at least portions of the telescopic system 110 comprising a telescopic system 110, can be supported at either end 94a, 94b, and allowed to rotate along an axis of a shaft 68 relative to at least the fuselage 52 of the satellite 50f. Such relative motion permits the decoupling of the fuselage 52 from at least portions of, if not all of, the optical path to permit more optimal and independent orientation of the satellite 50 for drag reduction, solar collection, and/or antenna pointing. Such displacement of the payload 58 relative to the fuselage 52 can accommodate changes in orientation and/or the direction at which the remote sensing system 100 obtains images and/or information without changing the orientation of the fuselage 52 in a manner that could otherwise increase atmospheric drag on the satellite 50f.

Although the rectangular block depicted in FIG. 8A is intended to represent the telescopic payload 58 in the form of a telescopic system 110, it will be appreciated in the description of FIG. 8A that the relative rotation can be between all or part of the optical path of the telescope of the telescopic system 110. For example, FIG. 8B illustrates changes in the field of view associated with changes in the angular orientation of the payload 58, or portions thereof, relative to the fuselage 52. In the depicted embodiment, the angular orientation of the payload 58, or portions thereof, relative to the fuselage 52 can be adjusted such that the payload 58 can be positioned at a first location to attained a first field of view 64′ and at an opposing second position to attain a second field of 64″, as well positioned therebetween to attain other fields of view 64. According to certain embodiments, the payload 58, or portion thereof, can be rotated approximately 70 degrees from a central position to the first or second position. Such changes in the angular orientation of the payload 58, or portions thereof, can be attained via operation of an actuator 96 in a manner similar to that discussed above with respect to the actuator 72 shown in FIG. 6. Additionally, according to certain embodiments, the remote sensing system 100 can include or more sensors, such as, for example, an encoder, that can be utilized by the controller 102 to determine the position of the actuator 96, and thus the angular position or orientation of the displaceable payload 58, or the displaced portions thereof.

In some forms the payload 58, or portions thereof, can be supported at just one location, whether that location is at an axial end of the payload 58 or intermediate the forward and aft axial end. The coupling between the payload 58, or portions thereof, and the fuselage 52 can be accomplished using any variety of bearing arrangement, including a plain bearing, ball bearing, magnetic bearing, flexture, etc. While the shaft 68 can be a singular elongate shaft extending through the payload 58, in some form multiple shafts 68 are utilized, whether or not physically connected together or simply coupled together via other structure in the payload 58. Allowing the payload 58 to rotate freely relative to the longitudinal body 58 permits a relatively large range of lateral motion in the field of view 64, as depicted in FIG. 8B.

The first mirror 66 is not illustrated in FIG. 8A, but is rather incorporated into the rectangular block used to depict the other components in the illustrations above. Additionally, although the field of view 64 is shown in FIG. 8A as being intermediate the forward and aft end of the rectangular block, in some forms the first mirror 66 may be outside of the pivot points 92 (e.g. the first mirror 66 can be located aft of the rectangular block used to depict the remaining components of the payload 58, where the remaining components depicted by the rectangular block in FIG. 8A is supported at the pivot points 92 via a support such as, for example, a bearing at the forward end of the satellite 50f, among other forms and locations of supports.

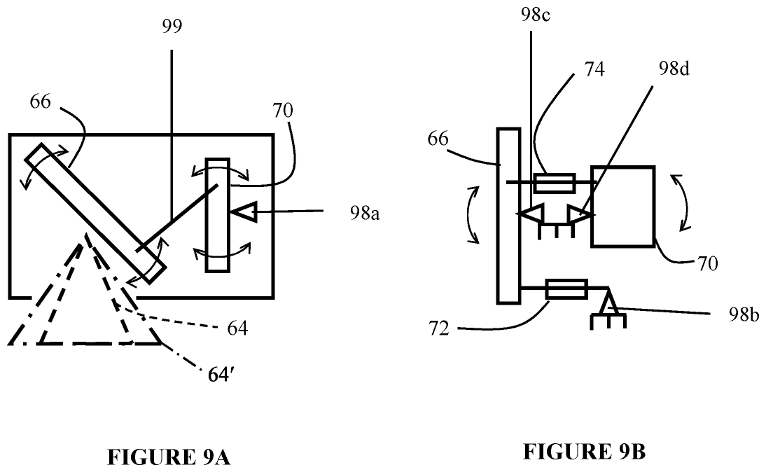

FIGS. 9A and 9B represent additional and/or alternative embodiments to those described elsewhere regarding operation of the first mirror 66 as it moves to adjust the field of view 64, and a counter-acting mass or null mass 70 used to null the moment imparted to the satellite via motion of the mirror 66. While FIGS. 9A and 9B depict uses of null massed 70 with moveable mirrors 66, similar embodiments are also applicable to the moveable payload, or moveable portion of the payload 58, that is discussed above with respect to FIGS. 8A and 8B, among other embodiments discussed herein. Further, the arc shaped arrows shown in FIGS. 9A and 9B indicate potential movements about the various pivot points 98a-d which are depicted as triangles in these and other figures herein.

The movable mirror 66, such as, for example, the moveable mirrors 66 discussed above with respect to at least FIG. 6, 8A, and 8B, can result in a torque being exerted on the satellite 50 as the moveable mirror 66 is aimed about. Such torque can attribute to vehicle attitude disturbance of the satellite 50, which can lead to the satellite 50 experiencing an undesirable increase in atmospheric drag. However, by coupling the moveable mirror 66 to a movable null mass 70 that opposes mirror inertia, the satellite 50 can experience reduced disturbing torque. Such coupling between the mirror 66 and null mass 70 can, for example, be via a physical mechanism such as gears or linkages, or via positioning force produced via an actuator. The movable mirror can be actuated against the null mass 70 and/or with respect to the vehicle 50.

FIG. 9A illustrates an embodiment in which the mirror 66 is coupled to the null mass 70 via a single linkage 99. The mirror 66 can be coupled to an associated support that can accommodate pivotal or rotatable displacement of the mirror 66. The null mass 70 can also be coupled to a support that can accommodate rotational and/or linear movement of the null mass 70 in a direction that can oppose inertia generated by the displacement of the mirror 66. According to the illustrated embodiment, depending on the direction at which the mirror 66 is rotatably displaced, the movement of the mirror 66 can be translated to the null mass 70 via the linkage 99 so that the linkage 99 can exert either a pulling or pushing force on the null mass 70. Accordingly, the null mass 70 can have a weight that is selected to counter or minimize the inertia generated by movement of the mirror 64. Further, the null mass 70 can have a variety of shapes and configurations, including, for example, being a wheel or a bar(s) of material, including, but not limited to, a bar(s) of lead or tungsten.

FIG. 9B illustrates another embodiment in which, similar to FIG. 6, the mirror 66 is movable via operation of an actuator 72 that is directly or indirectly coupled to a reference surface, such as, for example, a surface of the fuselage 52. Additionally, as seen in FIG. 9B, the mirror 66 is also coupled to the null mass 70 via another, or separate, actuator 74. The pivot points 98b-d can be coupled to one or more of the reference surfaces, such as, for example, one or more surfaces of the fuselage 52. The actuators 72, 74 can be any type of suitable actuator used in the satellite 50, such as, but not limited to, thermal actuators, electric actuators, pneumatic actuators, hydraulic actuators, and/or electromechanical actuators, among others, as well as combinations thereof. According to such an embodiment, actuation of the actuator 72 to rotatably displace the mirror 66 can coincide with actuation of the actuator 74 that is coupled to the mirror 66 and the null mass 70 so that displacement of the null mass 70 can generate an inertia to counter, or oppose, the inertia generated by the displacement of the mirror 66.

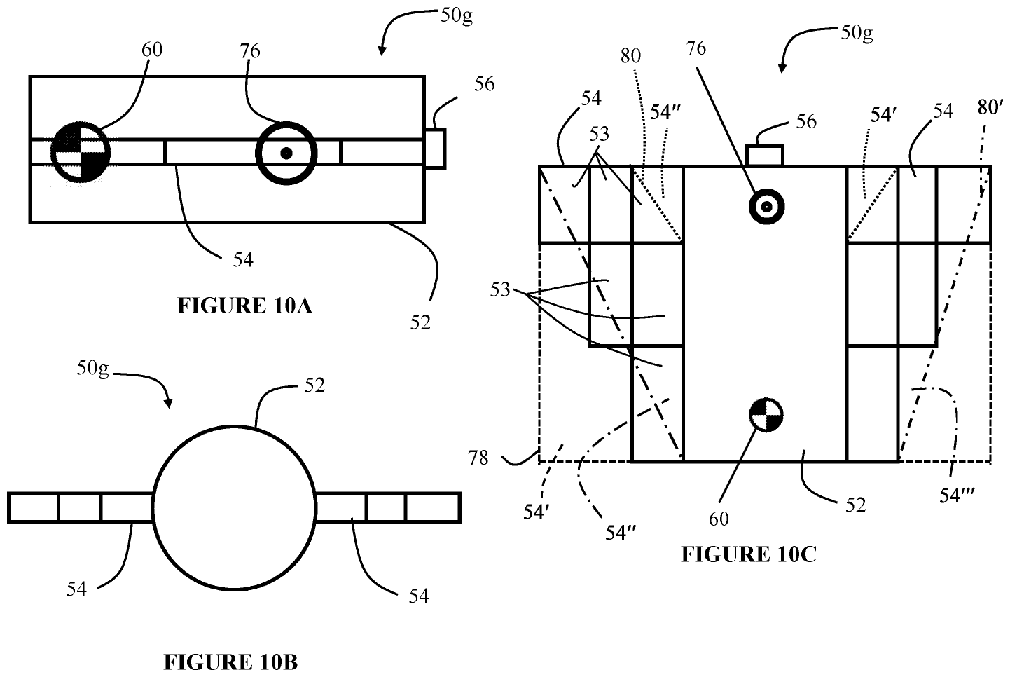

FIGS. 10A-10C illustrate relative placement of the CoM 60 and the center of drag (center of pressure) 76. As shown, the satellite 50g can include one or more protrusions, including, but not limited to, a wing(s), tab(s), spoiler, or fin(s) that is/are positioned to bias the position of the center of drag 70 to a position behind the CoM 60. For example, FIGS. 10A and 10B illustrate a satellite 50g having a pair of wings or fins 54 disposed on opposing sides of the fuselage 58 that are shaped to bias the center of drag 76 to the rear of the vehicle while the CoM 60 remains forward of the center of drag 76. Such relative placement of the CoM 60 and the center of drag 76 can aid in providing a positive natural stability (either static or dynamic) to the satellite 50g as the satellite develops atmospheric drag, however small, when the satellite 50g is at the orbital altitude.

FIG. 10C illustrates three different examples of configurations of wings or fins 54, 54′, 54″, 54′″. The shape of the wings or fins 54 depicted in FIG. 8C by the solid lines are generally represented by a faceted, swept configuration. Each of the facets 53 can represent an individual building block of a wing or fin 54, or an individual solar cell, etc. The dashed rectangular lines 78 represent an alternative shape for the wings or fin fins 54′ that can provide a more forward location of the center of drag 76. The angled dashed lines 80, 80′ represent yet other alternative embodiments in which the wings or fins 54″, 54″′ can also take a swept configuration. In the various embodiments the geometric center of the planform shape (the planform can be seen in FIG. 10C) of the wings or fins 54 can also remain aft of the CoM 60, which in some cases can be a sufficient proxy to ensure positive natural stability of the satellite As will be appreciated by other discussion herein, the wings or fins 54 can take on any size and shape, and can be used for solar arrays or antennas and/or for altering the center of drag or pressure 76 of the satellite 50g, or the geometric center of the planform of the fins 54.

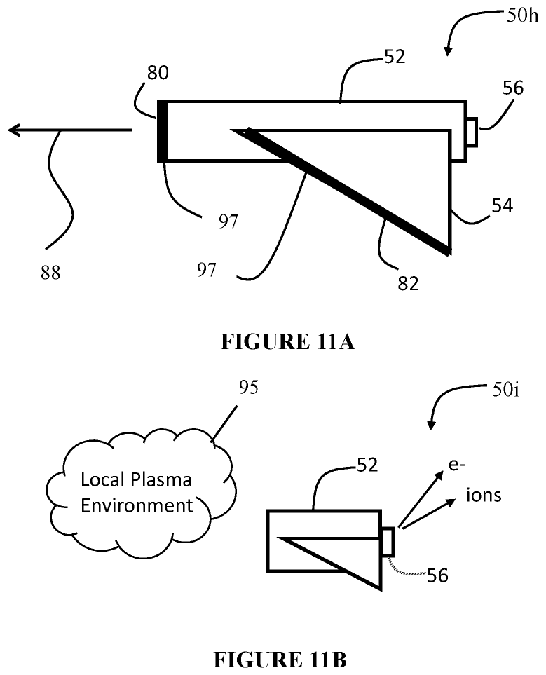

FIGS. 11A and 11B represent additional and/or alternative forms of the satellite 50h, 50i which represent techniques useful to protect the satellite 50h, 50i. For example, atmospheric drag can subject exterior surfaces of the satellite 50h, 50i to erosion and degradation via mechanical, electrical, and chemical interactions. FIG. 11A discloses a forward end 80 of the longitudinal body 52 and/or leading edge 82 of the fin 54 of the satellite 50h having a protective material 97 suitable to discourage degradation in the local plasma environment. Application of the protective material 97 in these and/or other areas if the satellite 50h can enhance environmental resistance of exterior portions of the satellite 50h to damage. In the illustrated example, an end such as, for example, a front end, of the fuselage 52 and/or leading edge 82 of a wing(s) or fin(s) 54 can be coated with, or otherwise include a layer, film, and/or barrier of the protective material 97. Further, the protective material 97 can be a non-structural component of the satellite and can comprise a chemical/composition type suited for flight at the chosen orbital altitude. Examples of the protective material 97 can include, but is not limited to, certain types of glass and metals that can be generally immune to atomic oxygen, among other materials.

FIG. 11B represents a mode of operation of the rocket thruster 56 of the satellite that can alter the local plasma environment 95 in the vicinity of the satellite 50i. Moreover, the rocket thruster 56 can be operated in a mode to alter its local plasma potential for operating in environments with high concentrations of energetic ions & other damaging atmospheric particles. As illustrated in the embodiment, ejection of ions during operation of the rocket thruster 56 can alter the local environment sufficiently to further minimize interaction with the local plasma environment 95, and thus minimize drag effects. Moreover, the energy of an ion emitter and/or electron emitter of the rocket thruster 56 can be altered such that such that the ejection of ions from the rocket thruster 56 can alter the local plasma environment to provide protection to the exterior of the satellite 50i from degradation.

The embodiments of FIG. 11A and FIG. 11B can be used separately, but in some embodiments are both used for any given satellite 50.

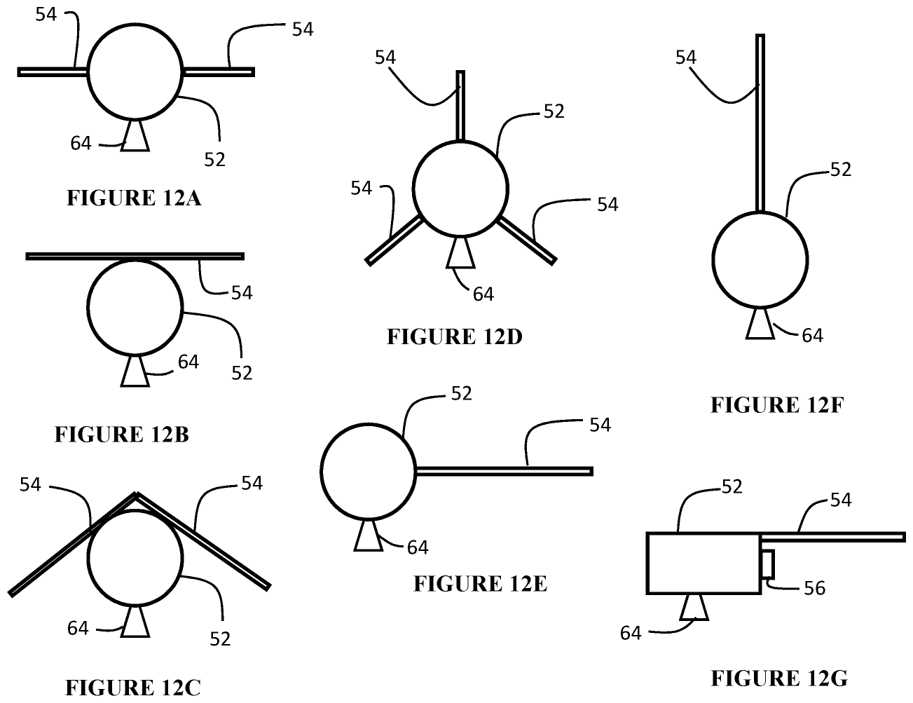

FIGS. 12A-12G illustrate various placement options for the wings or fin(s) 54. The body of fuselage 52 and the wings or fins 54 are depicted as simple circles and boxes, however as suggested above other shapes such as polygons and curves are also contemplated. For example, the wings or fins 54 can be small protrusions to full vehicle sized wings in any of the embodiments herein. Further, as will be appreciated, the fins 54 can be used for solar arrays or antennas and/or just for altering center of pressure only.

FIG. 12A represents fins 54 extending on either side of the fuselage 52. It will be appreciated that the fin(s) 54 in this and the other embodiments of FIGS. 12A-G can be constructed as multiple, independent wings or fins 54 that is/are attached at various locations, but in some forms can be an integrated single wing or fin 54 that is attached to or through the fuselage 52. Thus, for example, the wings or fins 54 shown in FIG. 10A can either be separate fins 54 attached to the fuselage 52, or a single fin that extends through the fuselage 52.

FIG. 12B represents a wing or fin 54 attached to a top side of the fuselage 52, although in other embodiments the wing or fin 54 can be attached to the bottom of the fuselage 52 provided accommodation is made for the field of view 64. The wing or fin 54 shown in FIG. 12B can be generally symmetrically located about the fuselage 52. FIG. 12C illustrates an anhedral configuration with the wings or fins 54 oriented in a downward direction. FIG. 12D represents an arrangement with wings or fins 54 circumferentially distributed about the fuselage 52. The circumferential distribution can be equiangular, but in some forms the angles between adjacent wings or fins 54 need not be the same.

FIGS. 12E and 12F represent a single wing or fin 54 extending out of a side of the fuselage 52, with a lateral extension of the wing or fin 54 being seen in FIG. 12E and a vertical extension if the wing or fin 54 being seen in FIG. 12F. Other angles are also contemplated beyond those shown in FIGS. 12E and 12F.

FIG. 12G illustrates yet another embodiment wherein the wing or fin 54 extends out the aft end of the fuselage 52. The wing or fin 54 shown in FIG. 12G can be attached to the aft end of the fuselage 52, but in some forms it can be attached to the top side of the fuselage 52 and extending an arbitrary distance along the top side. Such a configuration can sometimes be referred to as a shuttlecock, or bottle rocket, shape wherein the wing or fin 54 is in a trailing configuration.

In one aspect the present application provides an apparatus comprising: an orbital vehicle structured to operate at orbital altitudes between 50 miles and 23,000 miles above the Earth, the orbital vehicle having at least one fin and a fuselage structured to contain at least part of a telescopic payload, the at least one fin having a swept configuration between a forward end and a rearward end of the orbital vehicle, and a Hall-effect thruster coupled with the orbital vehicle and capable of producing thrust sufficient to discourage orbital decay of the orbital vehicle when operating at orbital altitude, wherein the telescopic payload is constructed to image the Earth along a path oriented at an angle transverse to an axis of extension of the fuselage, which further includes a first mirror that turns the path transverse to the axis of extension to an angular direction in proximity to the axis of extension, wherein the angle transverse to the axis of extension is larger than the angular direction in proximity to the axis of extension.

One feature of the present application includes wherein the first mirror is a simple flat mirror.

Another feature of the present application includes wherein the first mirror is a powered mirror.

Yet another feature of the present application includes wherein the first mirror is moveable relative to the fuselage of the orbital vehicle.

Still another feature of the present application includes wherein the first mirror is structured to rotate about an axis to change a relative angle between an optical path produced by the first mirror and the axis of extension of the fuselage.

Still yet another feature of the present application includes wherein the optical telescope includes a plurality of components, the plurality of components including the first mirror, and wherein at least one component of the plurality of components is structured to rotate about the axis of extension such that a viewing angle of the optical telescope can be moved laterally relative to the axis of extension.

Yet still another feature of the present application further includes an inertia nulling mechanism coupled with the first mirror such that when the first mirror is moved the inertia nulling mechanism provides a counter movement to produce a counter torque to a torque produced when the first mirror is moved.

Yet still another feature of the present application includes wherein the inertia nulling mechanism includes a counterweight.

Yet still another feature of the present application includes wherein the counterweight is mechanically coupled with the movable mirror through at least one mechanical link.

Yet still another feature of the present application includes wherein the counterweight is mechanically isolated from an actuator that drives the first mirror, and wherein the counterweight is movable via a counterweight actuator.

Yet still another feature of the present application includes wherein the counterweight actuator is coupled with both the movable mirror and the counterweight.

Yet still another feature of the present application includes wherein the telescopic payload is oriented toward the forward end of the orbital vehicle such that a center of mass of the orbital vehicle is forward of a center of drag when operating the orbital vehicle at the orbital altitude.

Yet still another feature of the present application includes wherein the at least one fin includes an extension on opposing lateral sides of the orbital vehicle.

Yet still another feature of the present application includes wherein the at least one fin includes at least one of a solar array and an antenna.

Yet still another feature of the present application includes wherein at least one fin includes a material composition structured to discourage degradation from energetic particles at orbital altitudes.

Yet still another feature of the present application includes wherein the Hall-effect thruster can be operated in a mode to alter the local plasma environment.

Yet still another feature of the present application includes wherein the at least one fin can be a single construction affixed to a top of the orbital vehicle and which extends past lateral edges of the fuselage.

Yet still another feature of the present application includes wherein the at least one fin can be oriented at an angle to a lateral axis of the orbital vehicle such that it has an anhedral arrangement relative to the direction of travel and the location of Earth during orbit.

Yet still another feature of the present application includes wherein the at least one fin is a single fin, and wherein the single fin protrudes laterally from the fuselage.

Yet still another feature of the present application includes wherein the at least one fin includes three separate fins arranged about the circumferential periphery of the fuselage.

Yet still another feature of the present application includes wherein the at least one fin extends out the top of the fuselage.

Yet still another feature of the present application includes wherein the at least one fin extends out the rear of the fuselage to form a shuttlecock configuration.

Another aspect of the present application includes an apparatus comprising: an orbital vehicle having swept fin and a longitudinally oriented body structured to contain at least part of a telescopic payload, a Hall-effect thruster at least partially disposed within the orbital vehicle and capable of producing thrust to counter atmospheric drag at an orbital altitude, wherein the telescopic payload is constructed to image the Earth at a right angle to the longitudinally oriented body, wherein a first mirror of the telescopic payload turns the optical path from the right angle to an angular direction along the longitudinally oriented body.

A feature of the present application includes wherein the first mirror is one of a simple flat mirror and a powered mirror.

Another feature of the present application includes wherein the first mirror is structured to be moveable relative to the longitudinally oriented body of the orbital vehicle.

Yet another feature of the present application includes wherein the first mirror is structured to rotate about the longitudinally oriented body to change a relative angle between an optical path produced by the first mirror and the longitudinally oriented body.

Still another feature of the present application includes wherein the telescopic payload includes a plurality of components including at least an imager and an optical element, the plurality of components including the first mirror, and wherein at least one component of the plurality of components is structured to rotate about the longitudinally oriented body such that a viewing angle of the telescopic payload can be moved.

Still yet another feature of the present application further includes an inertia nulling mechanism coupled with the first mirror such that when the first mirror is moved the inertia nulling mechanism provides a counter movement to produce a counter torque to a torque produced when the first mirror is moved.

Yet still another feature of the present application includes wherein the inertia nulling mechanism includes a counterweight.

Yet still another feature of the present application includes wherein the counterweight is mechanically coupled with the movable mirror through at least one mechanical link.

Yet still another feature of the present application includes wherein the counterweight is mechanically isolated from an actuator that drives the first mirror, and wherein the counterweight is movable via a counterweight actuator.

Yet still another feature of the present application includes wherein the counterweight actuator is coupled with both the movable mirror and the counterweight.

Yet still another feature of the present application includes wherein the telescopic payload is oriented toward a forward end of the orbital vehicle such that a center of mass of the orbital vehicle is forward of a geometric center determined from a planform shape of the orbital vehicle.

Yet still another feature of the present application includes wherein the at least one fin includes an extension on opposing lateral sides of the orbital vehicle.

Yet still another feature of the present application includes wherein the at least one fin includes at least one of a solar array and an antenna.

Yet still another feature of the present application includes wherein at least one fin includes a material composition structured to discourage degradation from energetic particles at orbital altitudes.

Yet still another feature of the present application includes wherein the Hall-effect thruster can be operated in a mode to change the charge potential of the orbital vehicle.

Yet still another feature of the present application includes wherein the at least one fin can be a single construction affixed to a top of the orbital vehicle and which extends past lateral edges of the longitudinally oriented body.

Yet still another feature of the present application includes wherein the at least one fin can be oriented at an angle to a lateral axis of the orbital vehicle such that it has an anhedral arrangement relative to the direction of travel and the location of Earth during orbit.

Yet still another feature of the present application includes wherein the at least one fin is a single fin, and wherein the single fin protrudes laterally from the longitudinally oriented body.

Yet still another feature of the present application includes wherein the at least one fin includes three separate fins arranged about the circumferential periphery of the longitudinally oriented body.

Yet still another feature of the present application includes wherein the at least one fin extends out the top of the longitudinally oriented body.

Yet still another feature of the present application includes wherein the at least one fin extends out the rear of the longitudinally oriented body to form a shuttlecock configuration.

Yet another aspect of the present application includes a method comprising: propelling an orbital vehicle with a Hall-effect thruster along a path of flight of the orbital vehicle, the orbital vehicle having a telescopic payload disposed in an interior of the orbital vehicle that extends along a longitudinal axis of the orbital vehicle, the telescopic payload located toward a forward end of the orbital vehicle such as to create a stabilizing location of the center of mass, and imagining the Earth with the telescopic payload as the orbital vehicle is orbiting, wherein the imaging the Earth includes viewing the Earth with the telescopic payload at a right angle direction to the longitudinal axis, and turning an optical path from the right angle direction to the longitudinal axis using a first mirror.

A feature of the present application includes wherein the first mirror is one of a simple flat mirror and a powered mirror, and which further includes moving the first mirror relative to the longitudinally oriented body of the orbital vehicle.

Another feature of the present application further includes rotating the first mirror about the longitudinally oriented body to change a relative angle between an optical path produced by the first mirror and the longitudinally oriented body.

Still another feature of the present application further includes operating an inertia nulling mechanism which is coupled with the first mirror such that when the first mirror is moved the inertia nulling mechanism provides a counter movement to produce a counter torque to a torque produced when the first mirror is moved.

Yet another feature of the present application includes wherein the inertia nulling mechanism includes a counterweight.

Still yet another feature of the present application includes wherein the counterweight is mechanically coupled with the movable mirror through at least one mechanical link.

Yet still another feature of the present application includes moving the counterweight in a configuration in which the counterweight is mechanically isolated from an actuator that drives the first mirror, and wherein the counterweight is movable via a counterweight actuator.

Yet still another feature of the present application includes wherein the counterweight actuator is coupled with both the movable mirror and the counterweight.

Yet still another feature of the present application includes wherein the at least one fin includes an extension on opposing lateral sides of the orbital vehicle.

Yet still another feature of the present application includes wherein the at least one fin includes at least one of a solar array and an antenna.

Yet still another feature of the present application includes wherein at least one fin includes a material composition structured to discourage degradation from energetic particles at orbital altitudes.

Yet still another feature of the present application further includes operating the Hall-effect thruster in a mode to change the charge potential of the orbital vehicle.

While embodiments of the disclosure have been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

1. An orbital satellite configured to operate at an orbital altitude that is least 50 miles above Earth, the orbital satellite comprising:
a fuselage defining an interior area, the fuselage having a generally elongated configuration that extends along an axis of extension of the fuselage;
an electric rocket engine coupled to the fuselage and positioned to provide a thrust force to propel the orbital satellite in a direction that generally coincides with the axis of extension, the thrust force sufficient to discourage orbital decay of the orbital satellite when operating at the orbital altitude;
a remote sensing system positioned within the interior area, the remote sensing system including an telescopic system adapted to inwardly redirect light that enters while traveling in a first direction into the orbital satellite to a second direction, an angle between the first direction and the axis of extension being larger than an angle between the second direction and the axis of extension.

2. The orbital satellite of claim 1, wherein the first direction is generally perpendicular to the axis of extension.

3. The orbital satellite of claim 2, wherein the remote sensing system is coupled to, or is part of, a payload that is positioned within the interior area, the payload being oriented toward a forward end of the orbital satellite such that a center of mass of the orbital satellite is forward of a center of drag when operating the orbital satellite at the orbital altitude.

4. The orbital satellite of claim 1, wherein the electric rocket engine is a Hall-effect thruster.

5. The orbital satellite of claim 1, wherein the telescopic system includes at least one mirror and at least one lens, the at least one mirror positioned to receive light that enters the orbital satellite in the first direction.

6. The orbital satellite of claim 5, wherein the at least one mirror comprises a mirror having a curved shaped profile that is configured to increase an optical gain.

7. The orbital satellite of claim 5, wherein the at least one mirror is selectively displaceable about an axis to change a relative angle between an optical path produced by the at least one mirror and the axis of extension of the fuselage.

8. The orbital satellite of claim 7, further including an inertia nulling mechanism coupled to the at least one mirror such that when the at least one mirror is selectively displaced, the inertia nulling mechanism provides a counter movement to produce a counter torque to a torque produced when the at least one mirror is moved.

9. The orbital satellite of claim 8, wherein the inertia nulling mechanism comprises a counterweight that is coupled to the at least one mirror by a linkage. The orbital satellite of claim 8, wherein the inertia nulling mechanism comprises a counterweight that is mechanically isolated from an actuator that drives a displacement of the at least one mirror, and wherein the counterweight is movable via a counterweight actuator.

11. The orbital satellite of claim 5, wherein the at least one mirror comprises a first mirror, a second mirror, and a third mirror, the first mirror and the second mirror each having a curved profile, the second mirror being downstream of, and smaller than, the first mirror, wherein at least a portion of the light that enters into the orbital satellite travels to each of the first mirror and the second mirror before being redirected in the second direction by the third mirror and toward the at least one lens.

12. The orbital satellite of claim 1, further including at least one fin coupled to the fuselage, the at least one fin including at least one of a solar array and an antenna.

13. The orbital satellite of claim 1, further including at least one fin coupled to fuselage, wherein at least one of a leading edge of the at least one fin and an end of the fuselage includes a protective material comprising a composition configured to resist degradation from particles at the orbital altitude, and wherein the protective material is, mechanically, a non-structural component of the orbital satellite.

14. The orbital satellite of claim 1, wherein the electric rocket engine is a Hall-effect thruster that is operated in a mode to alter a local plasma environment that is adjacent to the orbital satellite.

15. An apparatus comprising:
an orbital vehicle having at least one fin and a longitudinally elongated body structured to contain at least part of a telescopic payload;
an electric rocket engine coupled to the orbital vehicle and capable of producing thrust to counter atmospheric drag on the orbital vehicle when the orbital vehicle is at an orbital altitude,
wherein the telescopic payload is constructed to image the Earth at a right angle to the longitudinally oriented body, and
wherein at least one mirror of the telescopic payload turns an optical path containing the image from the right angle to an angular direction along the longitudinally elongated body.

16. The apparatus of claim 15, wherein the at least one mirror comprises at least a first mirror that is one of a simple flat mirror and a powered mirror.

17. The apparatus of claim 16, wherein the first mirror is structured to rotate about the longitudinally elongated body to change a relative angle between an optical path produced by the first mirror and the longitudinally elongated body.

18. The apparatus of claim 17, further including an inertia nulling mechanism coupled to the at least one mirror configured to provide a counter movement in response to a movement of the at least one mirror, the counter movement producing a counter torque that counters a torque produced when the least one mirror is moved.

19. The apparatus of claim 15, wherein the telescopic payload is oriented toward a forward end of the orbital vehicle such that a center of mass of the orbital vehicle is forward of a geometric center determined from a planform shape of the orbital vehicle.

20. The apparatus of claim 15, wherein the telescopic payload includes a first mirror, a second mirror and a third mirror, the first mirror and the second mirror each having a curved profile, the second mirror being downstream of, and smaller than, the first mirror, wherein at least a portion of a light that enters in a first direction into the orbital vehicle travels to each of the first mirror and the second mirror before being redirected in another direction by the third mirror and toward at least one lens of the telescopic payload.
